(19) United States
(12) Patent Application Publication
(10) Pub. No.: US 2008/0195603 A1
(43) Pub. Date: Aug. 14, 2008

(54) Transparent search engines

(75) Inventors: William Gross, Pasadena, CA (US); Tom McGovern, Pasadena, CA (US)

Correspondence Address: CHRISTIE, PARKER & HALE, LLP, PO BOX 7068, PASADENA, CA, 91109-7068, US

(73) Assignee: PERFECT MARKET TECHNOLOGIES, INC., Pasadena, CA (US)

(21) Appl. No.: 12/005,979

(22) Filed: Dec. 27, 2007

Related U.S. Application Data
(62) Division of application No. 11/006,078, filed on Dec. 6, 2004, now abandoned.
(60) Provisional application No. 60/527,023, filed on Dec. 4, 2003.

(51) Int. Cl. G06F 17/30

(52) U.S. Cl. 707/5; 707/E17.108

(57) ABSTRACT

A search apparatus includes a search engine administrator configured to receive at least one bid from a plurality of sponsors, each bid corresponding to a fee to be paid by a corresponding one of the sponsors for placement of an associated listing; and a search engine configured to receive a query from a user, identify a plurality of documents relevant to the query based, at least in part, on the bid of at least one of the plurality of sponsors, and generate a search results page with a listing for each of the identified documents, wherein display placement of each listing relative to other listings is based, at least in part, on the bid of at least one of the plurality of sponsors.

### CROSS-REFERENCE TO RELATED APPLICATION(S)

This application is a divisional of U.S. patent application Ser. No. 11/006,078, filed Dec. 6, 2004, which claims priority to and the benefit of U.S. provisional patent application No. 60/527,023, filed Dec. 4, 2003, the entire content of both of which is incorporated by reference herein.

### FIELD OF THE INVENTION

The present invention relates generally to a searching application, and more specifically to a searching application capable of providing additional information about websites identified in a search.

### BACKGROUND OF THE INVENTION

There are many search engines capable of searching computer networks for documents of interest, and generating listings of search results based on the documents identified in the search. Search engines often generate search results that include hyperlinks to underlying documents, thereby allowing a person browsing the search results to connect to and view a document of interest directly from the search results. Search results also typically include text that is descriptive of the underlying documents identified in the search. Such descriptive text, which is displayed as a result of a query, is usually created either by the search engine in an automated process, or by an individual in a specifically-tailored process. The organization of displayed search results for can be based on a wide variety of factors but is generally based upon their ‘relevance’ to the query submitted to the search engine. Determination of relevance can be achieved in various ways such as a rank assigned by the search engine (or its editors) or based on a payment made by a sponsor of a particular listing.

In particular, listing sponsors often pay search engine administrators fees in exchange for a listing, or for a more prominent listing, in search results. Listings that result from such a transaction between the search engine and sponsors are often referred to as “paid listings”. The payment arrangement is typically a charge to the listing sponsor when a person viewing the search result clicks-through from the search results listing to the sponsor's website. The amount of such charges can vary depending on a wide variety of factors including, but not limited to, the parties' perceptions of the monetary value of the search result listing and the anticipated traffic, and the quality of those visitors, generated by the search result listing. The arrangements between the sponsor and the search engine can be based on direct negotiations or through other market mechanisms such as sponsors bidding for the position in search results.

### SUMMARY OF THE INVENTION

A search apparatus includes a search engine administrator configured to 1 5 receive at least one bid from a plurality of sponsors, each bid corresponding to a fee to be paid by a corresponding one of the sponsors for placement of an associated listing; and a search engine configured to receive a query from a user, identify a plurality of documents relevant to the query based, at least in part, on the bid of at least one of the plurality of sponsors, and generate a search results page with a listing for each of the identified documents, wherein display placement of each listing relative to other listings is based, at least in part, on the bid of at least one of the plurality of sponsors.

### BRIEF DESCRIPTION OF THE DRAWINGS

Exemplary embodiments of the multi-dimensional sort list disclosed herein are illustrated in the accompanying drawings, which are for illustrative purposes only. The drawings comprise the following figures, in which like numerals indicate like parts.

FIG. 1 is a schematic illustration of a user interface for an exemplary embodiment of a multi-dimensional sort list.

FIG. 2 is a schematic illustration of the user interface of FIG. 1, wherein the displayed search listing has been sorted, or filtered, according to “Conversion rate for sale.”

FIG. 3 is a system diagram illustrating the components of an exemplary system configured to generate a multi-dimensional sort list.

FIG. 4 is a flowchart illustrating the operation of an exemplary search process using the multi-dimensional sort list disclosed herein.

### DETAILED DESCRIPTION OF THE INVENTION

A preferred embodiment of the present invention operates on the Internet, and more specifically, on the World Wide Web. The World Wide Web is based on, among other protocols, the Hypertext Transfer Protocol (HTTP), which uses a general connection-oriented protocol such as the Transmission Control Protocol/Internet Protocol (TCP/IP). However, the present invention is not limited to HTTP, nor to its use of TCP/IP or any other particular network architecture, software or hardware which may be described herein. The principles of the invention apply to other communications protocols, network architectures, hardware and software which may come to compete with or even supplant the state of the art at the time of the invention.

Throughout the following description, the term “website” is used to refer to a collection of content. Website content is often transmitted to users via one or more servers that implements the basic World Wide Web standards for the coding and transmission of HTML documents. It will be understood to one skilled in the art that the term “website” is not intended to imply a single geographic or physical location but also includes multiple geographically distributed servers that are interconnected via one or more communications systems.

Furthermore, while the following description relates to an embodiment utilizing the Internet and related protocols, other networks or hypermedia databases, such as networked interactive televisions, and other protocols can be used as well. For example, for use with cell phones, personal digital assistants (PDAs), and the like, HDML (Handheld Device Markup Language), WAP (Wireless Application Protocol), WML (wireless markup language), or the like can be used.

Additionally, unless otherwise indicated, the functions described herein are performed by programs including executable code or instructions running on one or more general-purpose computers. The computers can include one or more central processing units for executing program code, volatile memory, such as random access memory (RAM) for temporarily storing data and data structures during program execution, non-volatile memory, such as a hard disc drive or optical drive, for storing programs and data, including databases, and a network interface for accessing an intranet and/or the Internet. However, the functions described herein can also be implemented using special purpose computers, state machines, and/or hardwired electronic circuits. The example processes described herein do not necessarily have to be performed in the described sequence, and not all states have to be reached or performed.

Further, while the following description may refer to “clicking on” a link or button, or pressing a key to provide a command or make a selection, the commands or selections can also be made using other input techniques, such as using voice input, pen input, mousing or hovering over an input area, and/or the like. In addition, the terms “article”, “item” and “product” can be used interchangeably. As used herein, the term “click-through” is defined broadly, and refers, in addition to its ordinary meaning, to clicking on a hyperlink included within search result listings to view an underlying website.

As used herein, the term “document” is defined broadly, and includes, in addition to its ordinary meaning, and type of content, data or information, including without limitation, the content, data and information contained in computer files and websites. Content stored by servers and/or transmitted via the communications networks and systems described herein may be stored as a single document, a collection of documents, or even a portion of a document. Moreover, the term “document” is not limited to computer files containing text, but also includes computer files containing graphics, audio, video, and other multimedia data. Documents and/or portions of documents may be stored on one ore more servers.

As used herein, the term “listing”; is defined broadly, and includes, in addition to its ordinary meaning, a unique type of record displayed on a search results page where a sponsor or other party has provided specific information to be displayed as a result to a query of a search engine. Typically, an advertiser has sponsored, or paid, to have specific information and images displayed in an advertisement form. However, listings can also be generated in an automated fashion. Thus, listings are often classified as “paid” or “unpaid.” Listings resulting from a search and can be either in the form of a static text whereby the sponsor provides the information that it desires to be displayed, or dynamic whereby it is tailored by providing information that is updated for an individual search. Additional information regarding dynamic listings is provided in U.S. patent application Ser. No. 11/006,064, filed Dec. 6, 2004, the contents of which are hereby incorporated by reference.

As used herein, the term “listing sponsor” is defined broadly, and includes, in addition to its ordinary meaning, a person or organization sponsoring a document appearing in a search result listing generated by a search engine. Some documents may appear in a search result without a listing sponsor.

As used herein, the term “algorithmic results” is defined broadly, and includes, in addition to its ordinary meaning, search results based on an index of webpages where a computerized algorithm searches through the index and compiles search results based on relevancy to the query. The index is typically developed through computerized agents that access the World Wide Web through a process known in the art crawling and spidering.

As described in greater detail below, an example search apparatus provides a technique for facilitating a making environment directed towards displaying of search results. Listing display positions are in part established based on relevance as determined by supply and demand market forces. Sponsors may bid for display placement of their listings based on multiple alternatives including, but not limited to, the following arrangements; cost per thousand impressions (“CPM”) cost per click through (“CPC”) and cost per action such as a fee per completed transaction, percentage of the completed transaction, fee per download of a document or file, fee per lead for off-line business transaction, fee per new subscriber to a service or publication (“CPA”). The example apparatus also provides a technique for executing such search queries and displaying the results. An exemplary apparatus can determine the display placement, or relevance, of listings based on multiple attributes including the expected value to be paid by the sponsor through a system which scores bids based on a series of factors, and weighting of those factors, including the bid by the sponsor and previous performance of the listing. In a typical search, the results will include sponsored listings as well as algorithmic search results provided by conventional search engines such as Looksmart.com or AskJeeves.com. The apparatus may display other relevant ‘listing metrics’ such as the basis of the fee arrangement with the apparatus operator (CPM, CPC, CPA), the click through rate, the conversion rate for sales, the page views, and the like for the listing.

Advertisers can create listings and submit them to the search apparatus using several techniques. For example, in one embodiment the advertiser can submit the URL of the site they plan to advertise and the apparatus will visit that URL and develop a list of suggested search terms that the advertiser may want to consider for a sponsored listing. In another embodiment, the advertiser enters a keyword/search term and the apparatus will suggest related terms that the advertiser may consider. In still another embodiment, an advertiser may submit the URL of an unrelated document sponsor and the apparatus will provide all search terms for which the other sponsor has listings appearing. In any of the preceding examples, the advertiser can select the search terms that the apparatus will be associating the listing with and establishes other parameters such as duration of the listing and the basis of bids.

Access to the search engine apparatus can be either direct, such as by a user accessing the engine through a URL on the Internet, or through a distributed fashion. In one embodiment of the distributed fashion, an Internet publisher allows users of their site to submit a search query which is passed to the apparatus for processing; the search results are then returned and displayed by the Internet publisher. In another embodiment of the distributed fashion, the Internet publisher may display results from the apparatus each time a user accesses a page on the publisher's site based upon predetermined search queries which may be selected by the publisher, the operator of the search apparatus or through computerized selection of relevant search queries based on the content of the publisher's site.

In an exemplary embodiment, when a user accesses the search engine apparatus directly and executes a query, the user can sort, or filter, the listings based on one or more of the listing metrics to thereby order the search results so that those items that have certain characteristics or are more relevant to the user are listed higher up or first. For example, the user can sort, or filter, the search results so that those that have the highest number of page views are displayed first. Similarly, the user can sort the search results so that those that have the highest conversion rate are displayed first. Further, the user can sort, or filter, the search results so that those items that have certain characteristics or are less relevant to the user are listed lower down or last. For example, the user can sort, or filter, the search results so that those that have the highest sponsor price are displayed last. Thus, in contrast to conventional systems, which often fail to list the items most relevant to the user first because of placement sponsorships, one embodiment of the system disclosed herein enables the user to specify the ordering of the search results to thereby list the more relevant items higher up or first.

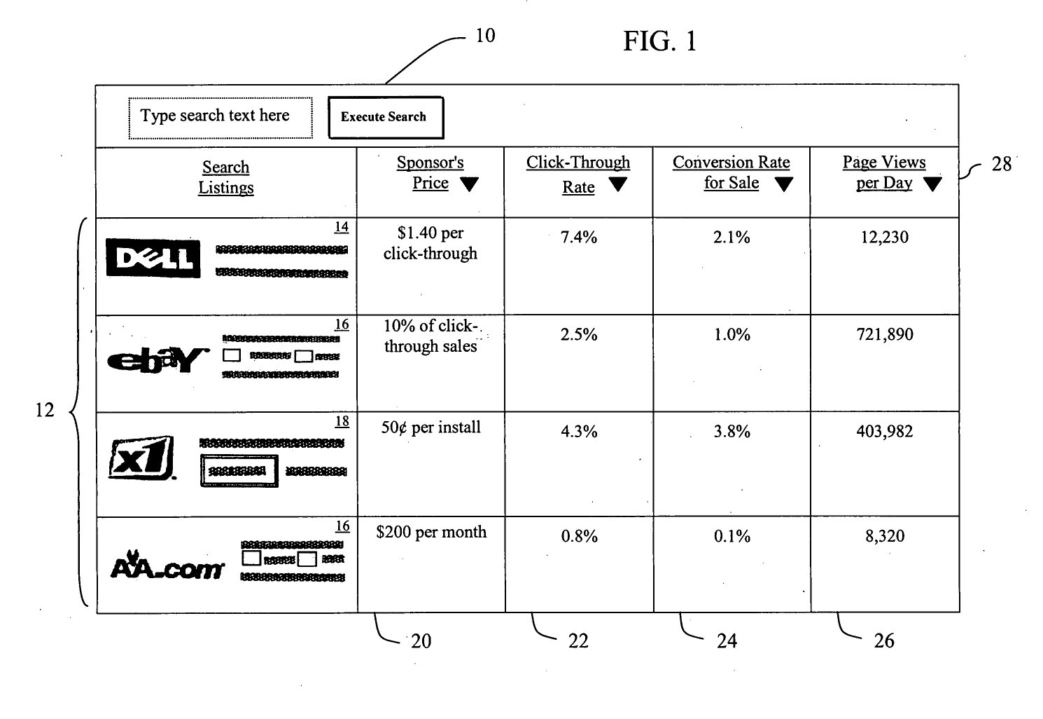

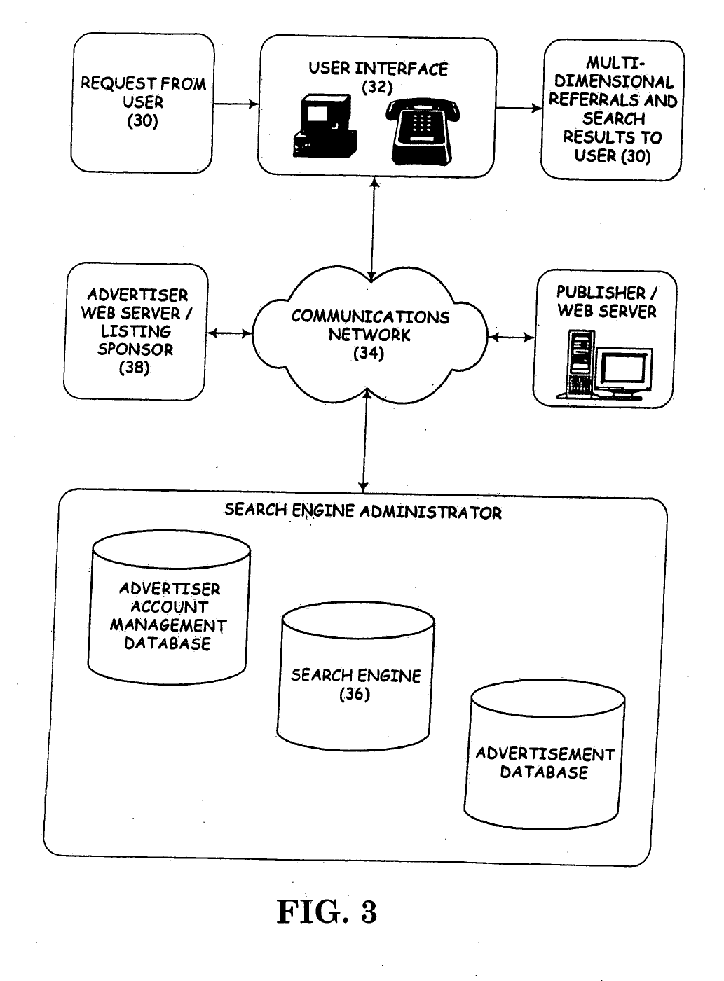

Thus, for example, the multi-dimensional sort list disclosed herein assists listing sponsors and search engine administrators in evaluating the numerous payment arrangements that exist between these two parties. The system can also be used by end-users reviewing search results generated by a search engine (referred to generally herein as “users”). FIG. 1 is a schematic illustration of a user interface for an exemplary embodiment of a multi-dimensional sort list 10. The multi-dimensional sort list 10 includes a plurality of search listings 12 that correspond to documents identified in a search of a computer network. The multi-dimensional sort list illustrated in FIG. 1 can be generated using the exemplary system that is schematically illustrated in FIG. 3.

Referring to FIGS. 1 and 3, the multi-dimensional sort list user interface 32 can be provided to the user 30 via a web page generated using HTML, JavaScript, XML, and the like, received from a website associated with the search engine 36. In other embodiments, other user interfaces capable of receiving information from the user 30 can be used, such as text-based user interfaces or audio-and voice-based user interfaces. In an exemplary embodiment, the search query is a text-based string of words or phrases that describe the subject matter to be searched.

For example, in one embodiment, the identified documents correspond to website documents, such as web pages, available on the Internet 34. In other embodiments, the documents are available on a communications network other than the Internet 34. The search listings 12 can include only static content (such as search listing 14), or can also include dynamically generated content (such as search listings 16). The search listings 12 optionally include an operational button configured to allow the user to quickly interface with the website corresponding to the search listing (such as search listing 18), such as by initiating a download or completing a transaction. Further information relating to search listings with dynamically generated content and/or with operational buttons is provided in U.S. patent application Ser. No. [Attorney Docket IDEALAB.049NP], the contents of which have been incorporated by reference.

Still referring to FIGS. 1 and 3, the multi-dimensional sort list optionally includes additional information, also referred to as ancillary information, about the search listings 12. The search engine administrator can independently compile such additional information by monitoring the activities of search engine users. For example, as illustrated in FIG. 3, ancillary information relating to a particular search listing 12 can be stored in an advertiser account management database or in an advertisement database. Additionally and optionally, the listing sponsor 38 can provide ancillary information to the search engine administrator, such as sales data, that can be used in the compilation of the additional information that is described in greater detail herein.

For example, in the exemplary embodiment illustrated in FIG. 1, a “Sponsor's Price” column 20 is included in the multi-dimensional sort list 10. In such embodiments, the column 20 indicates how much the listing sponsor 38 is paying the search engine administrator, if anything, to have the document listed with the search results generated by the search engine 36. In such embodiments, the column 20 includes information with respect to both price and measurement technique, although in other embodiments the column 20 can include one of price or measurement technique.

For example, a listing sponsor 38 can pay the search engine administrator based on a “fee-per-click-through” arrangement. In such an arrangement, the listing sponsor 38 is charged a fee each time a user 30 clicks-through from the search result listings to the underlying website. In another payment arrangement, the sponsor of a website that sells goods and/or services pays a commission to the search engine administrator based on sales to customers who are referred to the website from the search listings. In still other embodiments, the sponsor of a particular search listing 18 that includes an operational button pays the search engine administrator a fee each time a user 30 uses the operational button. A listing sponsor 38 can also pay the search engine administrator a fee to include the search listing in the search results for a predetermined time period, such as a day, a week, a month, or a year. Other payment arrangements can be used in other embodiments, including hybrid payment arrangements that use more than one of the exemplary arrangements described herein.

The “Sponsor's Price” column 20 provides particularly relevant information to listing sponsors 38 in embodiments wherein the search engine administrator allows listing sponsors 38 to bid for placement in the search listing results. One such system is disclosed in U.S. Pat. No. 6,269,361, entitled “System And Method For Influencing A Position On A Search Result List Generated By A Computer Network Search Engine,” which is hereby incorporated by reference. In particular, in such “bid-based” systems, listing sponsors 38 can use the information provided in the “Sponsor's Price” column 20 to determine what bid, if any, would be required to obtain a particular placement amongst the other search listings 12.

Still referring to FIGS. 1 and 3, the multi-dimensional sort list 10 optionally includes a “Click-Through Rate” column 22. In such embodiments, the column 22 indicates how often users 30 click-through to the website corresponding to a particular search listing, expressed as a percentage of the total number of times the search listing is presented to users 30. This provides search engine administrators and listing sponsors 38 with a measure of the magnitude of traffic a particular search listing is generating.

The multi-dimensional sort list 10 optionally includes a “Conversion Rate for Sale” column 24. In such embodiments the column 24 indicates how often users 30 who click-through to the website corresponding to a particular search listing purchase something at that website. This provides search engine administrators and listing sponsors 38 with a measure of the quality of traffic a particular search listing is generating. For example, a search listing with a relatively high conversion rate for sale indicates that the search listing is providing the underlying website with a stream of consumers that have an increased interest in products sold at that website. Conversely, a search listing with a relatively low conversion rate for sale indicates that the search listing is providing the underlying website with a stream of consumers that have a reduced interest in products sold at that website. This information can be used by the search engine administrators and/or the listing sponsors 38 to increase the efficacy of the search listings. This can be accomplished, for example, by changing the information provided in the search listing, or by changing the search terms associated with the search listing.

Still referring to FIG. 1, the multi-dimensional sort list 10 optionally includes a “Page Views per Day” column 26. In one such embodiment, the column 26 indicates how many users 30 have submitted searches whereby the listing was included in the search results. In another embodiment, the column 26 indicates how often a particular search result was actually displayed to the user. Although the exemplary user interface illustrated in FIG. 1 provides information on the number of page views per day, in other embodiments, other time intervals can be used, such as per hour, per week, per month, per year, or since the inception of the search listing. Similar to the click-through rate column 20, this provides search engine administrators and listing sponsors 38 with a measure of the magnitude of traffic a particular search listing is generating, as well as providing users an indication as to what search results are perceived as more relevant.

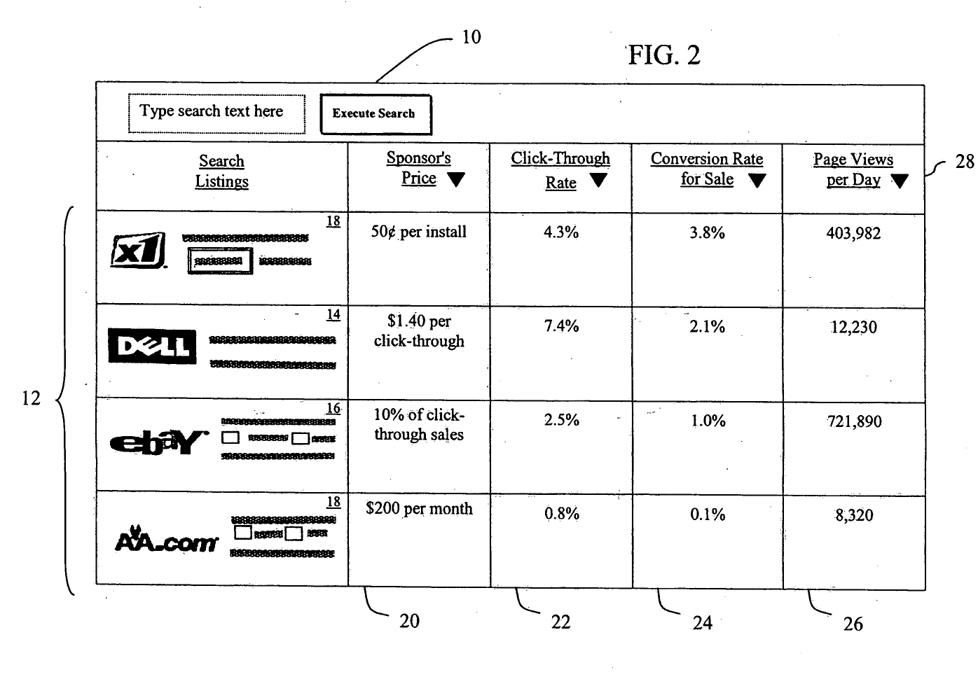

The search listings 12 can optionally be sorted, or filtered, according to a variety of different criteria. For example, in the exemplary embodiment illustrated in FIG. 1, the search listings can be sorted, or filtered, according to the values provided in any one of the columns 20, 22, 24 and 26. Thus, if the search listing with the highest conversion rate for sale is to be determined, the search listings 12 can be sorted, or filtered, according to column 24. For example, FIG. 2 illustrates the multi-dimensional sort list of FIG. 1 after being sorted, or filtered, according such that search listings with the highest conversion rate for sale are listed first. The search listings can also be sorted based on other factors, such as relevancy to the user's search terms, or alphabetically based on the search listing sponsor's name. In one embodiment, the column headings 28 comprise hyperlinks to a listing of search results sorted according to that heading; in such embodiments, the user clicks on a column heading to sort the search results according to the values on that column. In other embodiments, the user 30 can provide the search engine 36 with a sort order command using other techniques.

The search listings 12 can also be sorted, or filtered, based on the values on more than one of the columns 20, 22, 24 and 26. For example, the multi-dimensional sort list 10 can be configured to assign each search listing 12 a “relevancy score” based on specified parameters. This configuration allows different “weights” to be assigned to the various columns, wherein the relevancy score is a weighted average of the values in each column. Optionally, the relevancy score itself can be presented in a separate column in the multi-dimensional sort list 10.

The multi-dimensional sort list 10 optionally includes other meta data on the search results including: 1) date of the last update of the document at the URL of the search result, 2) top level domain of the search result (.com, .net, .edu) 3) country of the domain (.ca, .uk, .tw) 4) number of visitors to the URL, subdomain, domain after performing the same, or similar, search 5) link strength of the document located at the URL 6) file type at the URL of the search result (.html, .pdf, .mpeg etc.). Any of these maybe presented to the user in columns similar to FIG. 1 and may be sortable or filterable based on actions of the User. Further the Search Engine may utilize this meta data in its initial assessment of relevance of a document/listing to determine the relevance to a given search term.

The various sorting options listed herein are not limited to the parameters shown in FIG. 1. In particular, in other embodiments, the multi-dimensional sort list can include other columns providing other types of data on the search listings. Such configurations generally provide search engine administrators, listing sponsors 38, and/or users 30 with additional information regarding the search results that is not provided by conventional listings. In other embodiments, data can be provided with respect to web traffic patterns over the course of a day (such as, for example, busy in the evenings and idle during midday), or average purchase amount for users who purchase something from the search listing sponsor. Furthermore, the various sorting options disclosed herein can be saved, thereby allowing future searches to be sorted, or filtered, according to the same parameters.

In a modified embodiment, the user interface also provides information on searches that are related to the user's search query. Such information includes, for example, an estimated cost to a listing sponsor for purchasing a listing corresponding to related searches, and click-through rates corresponding to related searches. Other information can be included in other embodiments. This information can be provided in a tabular format, either simultaneous with the multi-dimensional sort list (for example, in a separate frame on the same screen), or on a separate screen that is linked from the multi-dimensional sort list.

For example, TABLE A below illustrates an exemplary related search information table provided to a user who has submitted a search query comprising the text string “laptop computer”. In particular, TABLE A provides several search queries that are related to “laptop computer” (for example, “notebook computer”); this advantageously allows listing sponsors to consider other search queries for which they may consider purchasing listings. The related search queries may be generated in any suitable manner. In one example, the system presents search queries entered into the search engine by other users of the engine that include one or more keywords contained in the search query in question. This also advantageously allows users to consider other search queries that may provide additional information related to the original search. In addition to the related search queries, TABLE A also provides an estimated cost to a listing sponsor (for example, on a CPC basis) for purchasing a listing corresponding to the listed search terms. Historical user click-through rates for the related searches are also optionally provided. Still other relevant information can be provided in other embodiments.

TABLE A

| Related | Estimated | Click-Through |
|---|---|---|
| Searches | Cost | Rate |
| laptop computer sale | 72 | 3.23% |
| used laptop computer | 65 | 3.18% |
| dell laptop computer | 61 | 3.06% |
| cheap laptop computer | 56 | 2.98% |
| refurbished laptop computer | 52 | 2.97% |
| battery laptop computer | 47 | 2.94% |
| free laptop computer | 45 | 4.80% |

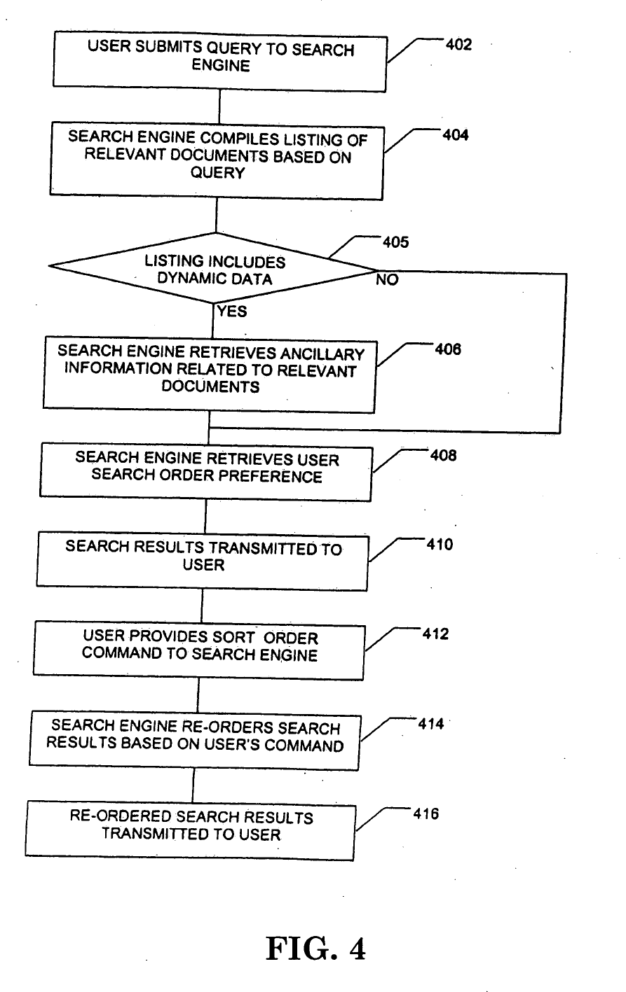

FIG. 4 illustrates an example search process. At state 402, a user submits a search query using a terminal, such as a computer terminal. For example, the search query can be provided via a web browser to a search engine over a network. The search engine can be accessed on a corresponding web site. The web site can include a web server application that accesses databases used to generate web pages in response to queries from end users. By way of example, the search engine may search server-based databases of the text of web pages selected from selected web pages. By way of example, the databases can be generated using a spider or the like that “crawls” the Internet searching for web pages, which are then stored in the databases and that follow the links in those web pages to other web pages, which are then stored in the databases. Because the databases, or portions thereof, may have been generated before a user submits a search query, these databases may not be fully current. When the search engine performs a web search in response to a user query, the search engine returns excerpts from relevant web pages as stored in a corresponding database, and also returns links to the current version of the web pages, if such exists.

Once a web page is stored, the web page is then indexed and the index is stored on a search engine server. At state 404, in response to the user query, the search engine searches the index based on the query or search terms, optionally including any Boolean terms. The search engine locates matches. Additionally and optionally, at state 406, the search engine can retrieve ancillary information related to the located items if the search results include listings that include dynamic data. For example, information on the sponsor price, click through rates, conversation rates, and page views can be retrieved from corresponding databases.

The Search Engine operator may provide Users access to the algorithm that determines the ranking order of search results to allow the User to modify and filter coefficients to tailor or customize the search results to their needs. For instance, if a user desires to weight documents from educational institutions higher the user may change the weight on domains and filter for only .edu. Such tailored algorithm coefficients may be saved as a preference.

At state 408, the search engine retrieves a user search order preference. By way of example, the preference can be stored in a user account record, or stored on the user terminal in a cookie or the like. The preference can specify a sort ordering and/or the weightings discussed above. At state 410, excerpts of the corresponding web pages, corresponding web page links, and the ancillary information are transmitted to the user terminal for display, ordered at least partly in response to the retrieved user preference.

At state 412, the user provides a sort command which is transmitted by the user browser over the network to the search engine. At state 414, the search engine reorders the search results in accordance with the sort command. At state 416, the reordered search results are transmitted back to the user terminal for display.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than use of multi-dimensional sort lists.

What is claimed:

1. A search apparatus comprising:
a search engine administrator configured to receive at least one bid from a plurality of sponsors, each bid corresponding to a fee to be paid by a corresponding one of the sponsors for placement of an associated listing; and
a search engine configured to:
a) receive a query from a user;
b) identify a plurality of documents relevant to the query based, at least in part, on the bid of at least one of the plurality of sponsors; and
c) generate a search results page with a listing for each of the identified documents; wherein display placement of each listing relative to other listings is based, at least in part, on the bid of at least one of the plurality of sponsors.

2. The search apparatus according to claim 1, wherein the plurality of identified documents comprises web pages.

3. The search apparatus according to claim 2, wherein the at least one bid from the plurality of sponsors is for a cost per action (CPA).

4. The search apparatus according to claim 3, wherein the CPA bid is for a fee per completed transaction between the user of the search apparatus and one of the plurality of sponsors from which the CPA bid is received.

5. The search apparatus according to claim 3, wherein the CPA bid is for a percentage of a completed transaction between the user of the search apparatus and one of the plurality of sponsors from which the CPA bid is received.

6. The search apparatus according to claim 3, wherein the CPA bid is for a combination of a sponsor's bid and previous performance of the listing.

7. The search apparatus according to claim 6, wherein the combination of the sponsor's bid and the previous performance of the listing is a conversion rate corresponding to the number of users of the search apparatus that purchase from one of the sponsors.

8. The search apparatus according to claim 3, wherein display placement of each document and sponsored listing in the search results page, relative to the other listings, is based at least in part on performance of at least one of the plurality of sponsors.

9. A search apparatus comprising:
a search engine administrator configured to receive at least one bid from a plurality of sponsors, each bid corresponding to a fee to be paid by a corresponding one of the sponsors for placement of an associated listing; and
a search engine configured to:
receive a query from a user;
identify a plurality of documents and cost per action (CPA).sponsored listings relevant to the query based, at least in part, on the bid of at least one of the plurality of sponsors; and
generate a search results page with a listing for each of the identified documents and CPA sponsored listings.

10. The search apparatus according to claim 9, wherein display placement of each document and sponsored listing in the search results page, relative to other listings, is based at least in part on the bid of at least one of the plurality of sponsors.
